(19) United States
(12) Patent Application Publication
(10) Pub. No.: US 2002/0024788 A1
(43) Pub. Date: Feb. 28, 2002

(54) Multiphase electricity pod controller device

(75) Inventor: Guy J. Lestician, Township of Lower Smithfield, PA (US)

Correspondence Address: Kenneth P. Glynn, 24 Mine Street, Flemington, NJ, 08822-1731, US

(73) Assignee: Power Saver Designs, Inc.

(21) Appl. No.: 09/828,037

(22) Filed: Apr. 6, 2001

Related U.S. Application Data
(63) Continuation-in-part of application No. 09/644,132, filed on Aug. 23, 2000.

(51) Int. Cl. H02H 3/22

(52) U.S. Cl. 361/111

(57) ABSTRACT

The present invention multiphase electricity pod controller device includes a plurality of subsystems, each subsystem having:

(a) in-parallel connection to an incoming power supply of a facility including a hot line and a neutral line, and at least one ground. There are components connected between the hot line and the neutral line in the following order:

(b) at least one front metal oxide varistor line transient voltage surge suppressor having a predetermined capability to suppress undesired power spikes;

(c) at least one capacitor of predetermined capacitance;

(d) at least two chokes in the form of inductor/metal oxide varistor transformers;

(e) at least a second capacitor of its own predetermined capacitance;

(f) at least one back metal oxide varistor having a predetermined capability. In preferred embodiments, the metal oxide varistor may be a plurality of varistors in parallel.

### BACKGROUND OF THE INVENTION

1. Field of the Invention

The present invention relates to conservation of electrical energy consumption by commercial, industrial, residential and all other energy consumers using retrofitted control devices which are attached at the incoming breakers to a facility and operate to increase efficiencies in a three stage process. The present invention device is specific to two phase and three phase systems.

2. Information Disclosure Statement

The following references are examples of the prior art relating to control of electrical energy consumption:

U.S. Pat. No. 4,163,218 relates to an electronic control system for controlling the operation of a plurality of electrical devices which are energized from AC power lines which includes a single, central unit connected to the power lines, which further includes a central transceiver means for transmitting an encoded oscillating signal of one frequency onto the power lines, a central encoding means for encoding the oscillating signal with an encoded signal in synchronization with the frequency of the AC power for selective control of electrical devices, and a central control means connected to the encoding means for selecting the electrical device to be controlled and its desired state. The invention further includes unitary switch units respectively interconnected between power lines and each electrical device being operative for both local and centralized control of the electrical device with the local control and the centralized control placing the electrical device in respective opposite states from each other, each switch unit including a switch transceiver means for receiving the encoded oscillating signal from the power lines, a switch decoding means coupled to the switch transceiver means for detecting the encoded signal, a switch control means connected to the switch decoding means for setting the selected electrical devices to the desired state, and a local control means for selectively locally operating the electrical device independently of the central unit and placing the electrical device in a state opposite from that which it was placed by the central unit.

U.S. Pat. No. 4,845,580 describes a spike elimination circuit for A.C. and D.C. power sources which comprises two gas tube and/or two semiconductor voltage limiting devices before a Bandpass Filter. The Bandpass Filter consists of 2 capacitors to ground an inductor in series with the line. The spike eliminator can be portable, mobile, or hard wired for the protection of home controls and electronics, telecommunications, commercial and industrial controls and the computer field and others.

U.S. Pat. No. 4,870,528 describes a surge suppressor which comprises a first series circuit having a first inductance and a first alternating voltage limiter, including at least a first capacitance and a bidirectionally conductive rectifying circuit for charging the first capacitance, coupled between first and second input terminals for limiting surge currents and voltage excursions coupled to first and second load output terminals. The first alternating voltage limiter further comprises a sensing circuit for sensing at least one of the charging current supplied to and the voltage developed across the first capacitance. An auxiliary energy storage circuit and a normally open switching device responsive to the sensing circuit are provided for coupling the auxiliary energy storage circuit across the first capacitance during high energy surge conditions.

U.S. Pat. No. 5,105,327 describes a power conditioner for AC power lines which has a choke and capacitor coupled in series across the power lines. The choke comprises a coil terminating in a line, with the line looped back through the coil. The power lines are thereby balanced to provide greater operating efficiency. Capacitors and transient suppressors (e.g., varistors) are used for transient suppression and power factor correction.

U.S. Pat. No. 5,420,741 relates to an arrangement for obtaining flux rate information in a magnetic circuit including passive means connected across a flux rate sensor for implementing control of said flux rate. The passive means being a tuned magnetic flux rate feedback sensing and control arrangement wherein impedance is tuned and the energy loss characteristic is adjustable. The selection of inductance and capacitance values provides tuning and the selection of resistance affects the energy loss characteristics.

U.S. Pat. No. 5,432,710 is directed to an energy supply system for supplying, in system interconnection, power at a power receiving equipment from a power plant and power generated by a fuel cell to a power consuming installation, and supplying heat generated by the fuel cell to a heat consuming installation. This system includes an operation amount computing device for computing an amount of operation of the fuel cell to minimize an equation y=aXL+bXM+cXN, in response to an energy demand of the power consuming installation and heat consuming installation. A control device controls the fuel cell to satisfy the amount of the operation computed. The system supplies energy in optimal conditions with respect to the cost borne by an energy consumer, consumption of primary energy, and release of environmental pollutants. Energy is effectively used from the standpoint of the energy consumer and a national point of view.

U.S. Pat. No. 5,436,513 relates to an information handling system which is described as having a power supply and having a switching circuit that switches a plurality of energy sources between series and parallel couplings. Associated with the switching circuit is a voltage level detecting circuit for monitoring the voltage level of the energy sources. A processor for controlling the information handling system responds to the voltage level detecting circuit and in the event of a low voltage condition, the processor activates the switching circuit to switch the energy sources and from a series to a parallel coupling. Alternatively, the processor responds to other inputs or conditions for actuating the switching circuit.

U.S. Pat. No. 5,459,459 is directed to an algorithm for implementation in a meter register and a reading device. In the one embodiment, the invention enables selecting a display table to be read from the register, updating the billing read date and time in the register, reversing the order in which load profile data is transmitted from the register to the reader, specifying the number of load profile intervals to be read from the register, and specifying the number of intervals to skip when reading from the register.

U.S. Pat. No. 5,462,225 relates to an apparatus and method for controlling energy supplied to a space conditioning load and for overriding a load control operation in response to measuring certain space temperatures within a closed environment. The load control apparatus includes a control device connected to an electrical distribution network and to a space/conditioning load and a temperature sensing device connected to the control device. The control device conducts a load shedding operation to control distribution of electrical energy to the space conditioning load in response to command signals supplied by a remote command center. The temperature sensing device operates to override the load shedding operation by outputting a control override signal to the control device in response to sensing certain space temperatures within the closed environment. If the temperature control device is connected to an air conditioning system, the temperature sensing device causes the control device to terminate the load shedding operation prior to expiration of a selected time period in response to measuring a space temperature that exceeds a maximum space temperature limit. In contrast, if the temperature control device is connected to a forced air heating system, the temperature sensing device causes the control device to terminate the load shedding operation when a measured space temperature drops below a minimum space temperature limit. The maximum space temperature limit is greater than the control temperature setpoint of a thermostat that controls the space conditioning operations, whereas the minimum space temperature limit is less than the control temperature setpoint.

U.S. Pat. No. 5,483,672 relates to a communication system, where a communication unit may conserve source energy when it is inactive in the following manner. The control channel is partitioned into a predetermined number of windows and a system window which are transmitted on the control channel in a round robin manner. When the communication unit registers with the communication system, it is assigned to a window group. The communication unit then monitors only the system window to determine whether the window group that its been assigned to is also assigned to one of the predetermined number of windows. When the window that has been assigned to the window group is being transmitted to the control channel, the communication unit activates to monitor that window. Once the window is no longer being transmitted, the communication unit deactivates until the system window is being transmitted or the window assigned to the window group is being transmitted.

U.S. Pat. No. 5,495,129 relates to an electronic device for multiplexing several loads to the terminals of a source of alternating electrical energy. The source of alternating electrical energy is coupled by electromagnetic flux to the loads by using primary excitation windings and connects to the terminals of the source of alternating electrical energy and secondary windings respectively corresponding to the number of loads. The secondary windings are at least partially coupled to the primary winding and are each connected to the terminals of a load. The coupling is inhibited by auxiliary winding which are each totally coupled with the secondary winding. The inhibition function is controlled in order to inhibit all the magnetic couplings except for one and this particular one changes as a function of the respective load to be coupled to the source of alternating electrical energy.

U.S. Pat. No. 5,512,831 relates to a system for testing electrochemical energy conversion and storage devices includes means for sensing the current from the storage device and varying the load across the storage device in response to the current sensed. The system is equally adaptable to batteries and fuel cells. Means is also provided to sense system parameters from a plurality of locations within the system. Certain parameters are then stored in digital form for archive purposes and certain other parameters are used to develop control signals in a host processor.

U.S. Pat. No. 5,517,188 is directed to a programmable identification apparatus, and associated method, includes a transceiver and a transponder. The transponder is powered by the energy of a transceiver transmit signal generated by the transceiver and includes a programmable memory element. A coded sequence which uniquely identifies the transponder is stored in the programmable memory element and, when the transponder is powered, the transponder generates a transponder signal which includes the coded sequence stored in the programmable memory element, once modulated by circuitry of the transponder. When the transceiver transmit signal generated by the transceiver circuitry is of certain signal characteristics, the coded sequence stored in the programmable element is erased, and a substitute coded sequence, which also forms a portion of the transceiver transmit signal, is stored in the programmable memory element. Storage of the coded sequence in the programmable memory element is, hence, effectuated merely by application of a transceiver transmit signal of certain characteristics to the transponder.

U.S. Pat. No. 5,528,123 measures the total line current in a power cord which is used to energize both a power factor corrected system and non-power factor corrected AC loads. The power factor control loop of the power factor corrected system is then driven to correct the power factor of total line current in the power cord ideally to approach unity.

U.S. Pat. No. 5,640,314 relates to a symmetrical ac power system which provides a balanced ac output, whose maximum voltage with respect to a reference ground potential is one-half the ac output voltage, and which is derived from a single phase ac source through the use of an isolation transformer having a center-tapped secondary winding. The center tap is connected to the output power load circuit as a ground reference potential with respect to the symmetrical ac output so as to constitute the reference ground potential for the power supply and load. Since symmetrical ac power is applied to the load by the system, reactive load currents, other power artifacts, EMI and RFI emissions and other interference and noise components ordinarily resulting from the application of conventional ac power to the load are reduced or eliminated by appearing as equal inversely phased signal elements which cancel one another. In order to maximize the performance of the symmetrical power system, the isolation transformer has a bifilar-wound secondary winding.

U.S. Pat. No. 5,646,458 describes a UPS (uninterruptible power system) which includes an UPS power conditioning unit that provides conditioned AC power to a critical load. The UPS power conditioning unit includes a variable speed drive that operates in response to AC utility power or to a standby DC input by providing a motor drive signal. The UPS power conditioning unit further includes a motor-generator that operates in response to the motor drive output by providing the conditioned AC power to the critical load. In response to an outage in the utility AC power, standby DC power is provided by a standby DC power source that includes a variable speed drive and a flywheel motor-generator connected to the variable speed drive. Both the UPS power conditioning unit and the standby DC power source are initially operated in response to the utility AC power, the flywheel motor-generator storing kinetic energy in a rotating flywheel. When an outage occurs, the rotating flywheel continues to operate the fly-wheel motor-generator of the standby DC power source, causing the production of AC power which is rectified and provided as standby DC power to operate the variable speed drive of the UPS power conditioning unit until either the utility AC power outage is over or a standby emergency generator is brought on line.

U.S. Pat. No. 5,880,677 relates to a system that monitors and controls electrical power consumption that will be retrofitted to a typical consumer electrical power arrangement (typical arrangement-electrical feed line from a provider, a meter, a circuit breaker and individual input wiring to a plurality of electrical devices, appliances and outlets). The system includes a control unit which receives information from an electromagnetic pickup device from which real time electrical consumption is determined over very short periods of time. The control unit has a main data processing and storage processor for retaining information and it may include a communication microprocessor for sending signals to corresponding modules. The electromagnetic pickup device uniquely measures the electromagnetic flux emanating at each output wire from each of the individual circuit breakers in a breaker box. The modules have filters which release electrical power to the individual electrical devices, appliances and outlets at a controlled, economic rate.

U.S. Pat. No. 5,892,667 describes a symmetrical ac power system which provides a balanced ac output, whose maximum voltage with respect to a reference ground potential is one-half the ac output voltage, and which is derived from a single phase ac source through the use of an isolation transformer having a center-tapped secondary winding. The center tap is connected to the output power load circuit as a ground reference potential with respect to the symmetrical ac output so as to constitute the reference ground potential for the power supply and load. Since symmetrical ac power is applied to the load by the system, reactive load currents, other power artifacts, EMI and RFI emissions and other interference ad noise components ordinarily resulting from the application of conventional ac power to the load are reduced or eliminated by appearing as equal inversely phased signal elements which cancel one another. In order to maximize the performance of the symmetrical power system, the isolation transformer has a bifilar-wound secondary winding.

U.S. Pat. No. 6,009,004 discloses a new single-phase passive harmonic filter for one or more nonlinear loads. The filter improves the total system performance by drastically reducing the line side current harmonics generated by nonlinear loads. The filter includes two inductive portions across one of which is connected a tuning capacitor. The parallel combination of one inductive portion with the tuning capacitor forms a series tuned filter configuration while the second inductive portion is used for harmonic attenuation. A shunt capacitor is employed for shunting higher order harmonic components. A single-phase passive voltage regulator provides the needed voltage bucking to prevent over voltage at the load terminals of the filter. The filter provides an alternate path for the harmonic currents generated by nonlinear loads. The over voltage caused by the increased capacitive reactance is controlled by either capacitor switching or by the use of the passive voltage regulator or a combination of the two. Capacitor switching is dependent upon load conditions.

U.S. Pat. No. 6,014,017 describes a method and an apparatus for power factor correction for a non-ideal load, which is supplied from a mains power supply, by a compensation device which is electrically connected in parallel with the load and has a pulse converter with at least one capacitive store. A transfer function space vector is calculated as a function of a determined mains power supply voltage space vector, a mains power supply current space vector, a compensator current space vector and of an intermediate circuit voltage which is present on the capacitive store. As a result of which the pulse converter generates a compensator voltage space vector on the mains power supply side as a function of the intermediate circuit voltage. A compensator current space vector, that keeps the undesirable reactive current elements away from the mains power supply, is thus obtained via a coupling filter that is represented as a compensator inductance.

U.S. Pat. No. 6,058,035 describes a method wherein after starting the input of a switching signal to a booster circuit whose boosting rate is changeable in accordance with the duty ratio of the inputted switching signal and calculating the output power of an invertor circuit, which is connected to the subsequent stage of the booster circuit, from the output current of the invertor circuit, the target voltage after boosting by the booster circuit is obtained based on the output power. If the actual output voltage of the booster circuit is lower than the target voltage, the duty ratio of the above switching signal is increased, and if higher, the duty ratio of the above switching signal is decreased.

Notwithstanding the above prior art, there are no teachings or suggestions that would render the present invention anticipated or obvious.

### SUMMARY OF THE INVENTION

The present invention is an electricity pod controller device, which includes connection for connecting the device in parallel with an incoming power supply to a facility, i.e. a home, factory, office, institution, etc.; a first stage component, a second state component and a third stage component. The first stage is adapted to recognize electromagnetic interference, and to respond thereto by suppressing live transient voltage surges, and thus includes at least one line transient voltage surge suppressor (TVSS). The TVSS may be one or more metal oxide varistors and is preferably a plurality of in-parallel metal oxide varistors.

The second stage component includes at least one variable inductor to regulate the total harmonics distortion (THD) and thus enhance power factor correction. This would include chokes (transformers) and storage. The third stage component includes hardware to provide power to maintain phase regulation to incoming power, thus, to maintain true phase relationship between voltage and current at times of increased power demands. The third stage component includes at least one power storage and discharge element.

In some embodiments, the present invention is arranged so that the first stage component, second stage component and third stage component operate in a two phase system. In these embodiments, there subsystem having a first stage component, a second stage component and a third stage component, such that the device operates as a two phase device. In other embodiments,the aforesaid two phase device is coupled with a single phase device disclosed in the parent application to create a three phase device. In yet other embodiments, the electricity pod controller device of the present invention has three sets of subsystems, each set having a first stage component, a second stage component and a third stage component, wherein the device operates as a three phase device either for a delta three phase system or for a Y-three phase system.

More specifically, preferred embodiments of the present invention electricity pod controller device include in each subsystem:

(a) connecting means for connection to an incoming power supply of a facility, for connection in parallel, including a hot line and a neutral line, and at least one ground, and has a number of important components connected between said hot line and said neutral line. They are connected in the following order travelling in a direction away from the connections:

(b) at least one front metal oxide varistor line transient voltage surge suppressor having a predetermined capability to suppress undesired power spikes (“front” is used to mean closer to the connection and “back” is used to mean further away from the connection);

(c) at least one capacitor of predetermined capacitance;

(d) at least two chokes in the form of inductor/metal oxide varistor transformers;

(e) at least a second capacitor of its own predetermined capacitance;

(f) at least one back metal oxide varistor having a predetermined capability. In preferred embodiments, the front metal oxide varistor is a plurality of varistors in parallel. It has been discovered that a plurality of smaller varistors having the same total capability as one larger varistor responds more quickly than one large varistor. For similar reasons, it is preferred that the back metal oxide varistor be a plurality of varistors in parallel.

In some embodiments, the components (b) through (f) above are arranged for operation as a two phase device, by duplication of what has been described in the parent application hereto as a single phase arrangement, to form two connected subsets or subsystems thereof. In yet other embodiments, all of the individual components forming a single subsystem are triplicated to form three connected sets thereof and are thus arranged for operation as a three phase device.

The electricity pod controller device of the present invention may further include at least one indicator lamp connection and lamp wired so as to illuminate when the device is functional and to not illuminate when the device is non-functional.

### BRIEF DESCRIPTION OF THE DRAWINGS

The present invention should be more fully understood when the specification herein is taken in conjunction with the drawings appended hereto, wherein:

FIG. 1 shows a flow chart of the concept of an electricity pod controller, including a single subsystem of the present invention in symbolic form;

FIG. 2 shows a wiring diagram of one preferred embodiment of an electricity pod controller for single phase operation which is duplicated or triplicated for present invention multiphase devices;

FIG. 3 illustrates a wiring diagram for a preferred embodiment of the present invention electricity pod controller for two phase operation; and,

FIGS. 4a and 4b show a wiring diagram of another preferred embodiment of the present invention electricity pod controller for three phase operation.

### DETAILED DESCRIPTION OF THE PRESENT INVENTION

In a normal electrical power consumption situation, electricity is transmitted through power lines or transmission lines to a facility, e.g. the home, office, factory or other consumers, wherein the main line is typically connected to an electrical meter, and from the meter to a main breaker box (or, in earlier times, a main fuse box). Within the main breaker box, the main power line is connected to a plurality of individual circuit breakers which then lead to various power consumption devices such as heating, air conditioning, lighting and electrical outlets. While this arrangement works adequately to provide electrical power to the consumer, it is inefficient because many electrically powered devices and appliances consume more power than necessary and, additionally, they experience spikes, surges and phase shifts, which make the overall system inefficient and uneconomic.

The present invention relates to two phase and three phase devices which are correspondingly retrofitted to existing two phase and three phase electrical power arrangements for the purpose of reducing unnecessary electrical power waste and losses by reducing or eliminating spikes, surges and phase problems. These are totally self-sufficient devices which are attached downstream from or at the last breaker of the system or the last breaker to be regulated.

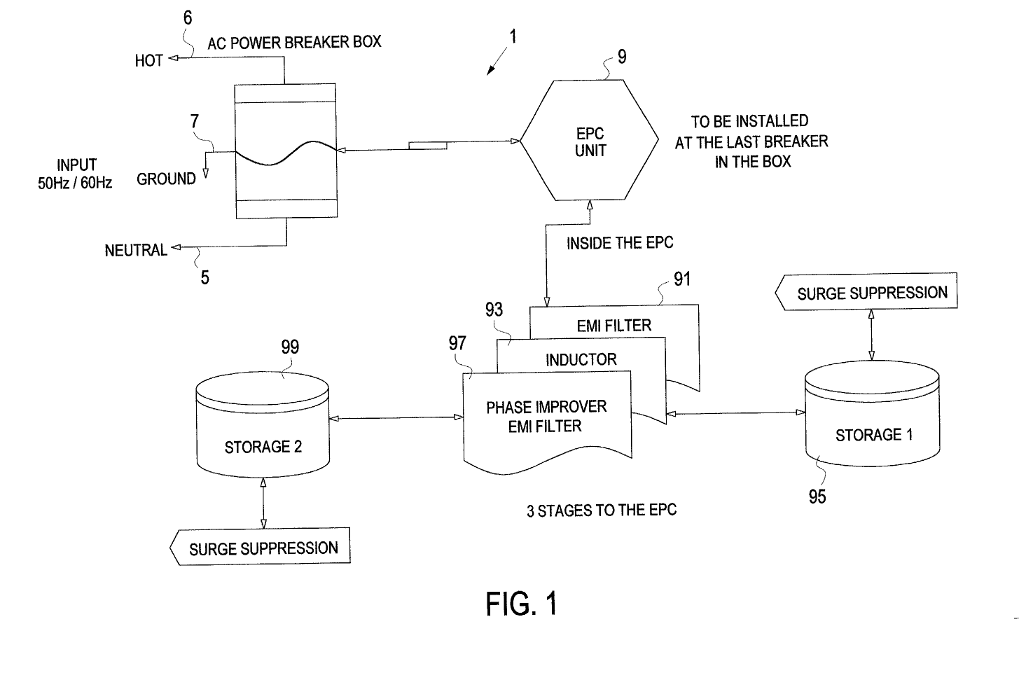

FIG. 1 illustrates a flow chart of one embodiment of an electricity pod controller of the parent application invention in symbolic representation. It includes a single phase circuit which is duplicated and triplicated in the present invention devices. The diagram shows a flow chart 1. It includes connections to the breaker box including hot wire 3 and neutral wire 5. There is also a ground 7. The electricity pod controller unit 9, to be most efficient, is installed at the last breaker in the box of a facility in order to act upon all of the power flowing into the facility through those breakers.

Electricity pod controller unit 9 is shown to contain an electromagnetic interference filter 91, an inductor 93 with storage for surge suppression, and a phase improving EMI filter 97 with storage 99, also for surge suppression. This is designed to operate within the preferred range of 80 to 440 volts or even a broader range of 25 to about 500 volts of AC input at 30 to 80 kilohertz.

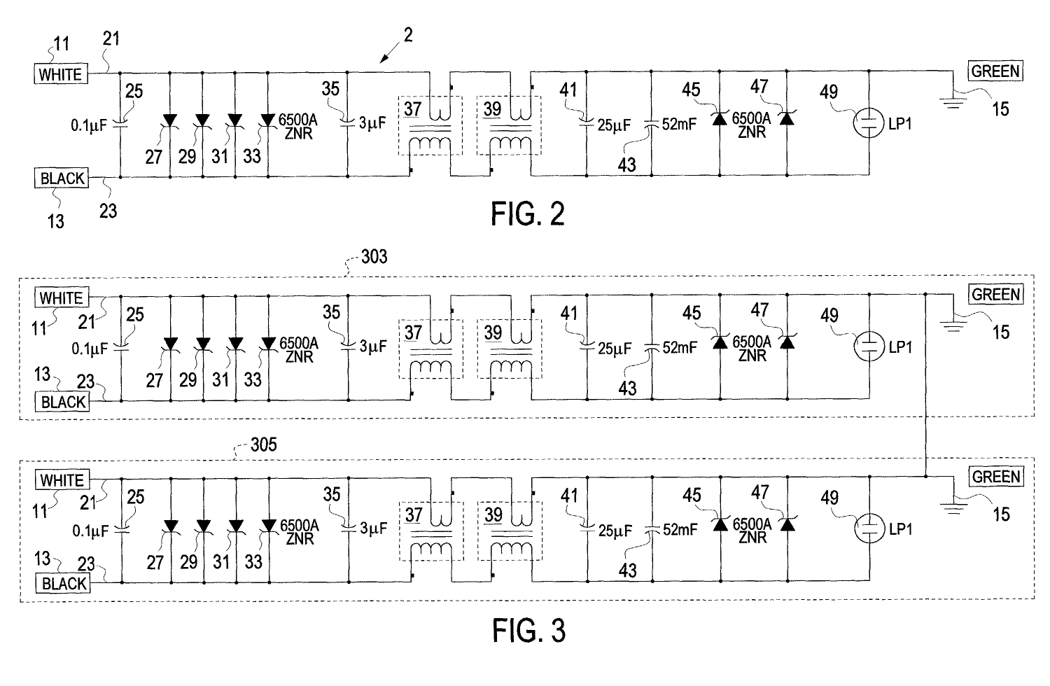

FIG. 2 shows a wiring diagram of one preferred embodiment of the parent application invention electricity pod controller for single phase operation. There is a white contact 11 and a black contact 13 with ground 15 as shown. For simplicity, the various components are shown and are described as being wired between neutral line 21 and hot line 23 and are described sequentially herein in an order beginning at the connections 11 and 13 and moving outwardly or away from those connections.

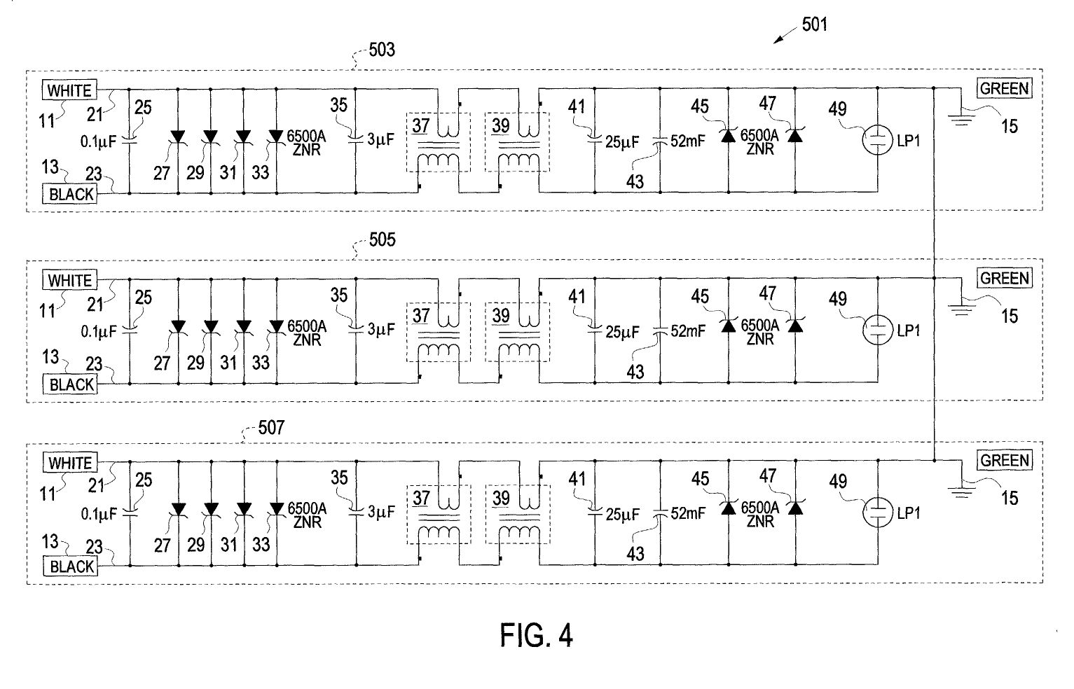

Thus the components in the wiring diagram of FIG. 2 represent a single phase device and include a surge suppression-type capacitor 25 (in this case, 0.1 microfarads and in general about 0.001 to 1.0 microfarads) followed by a plurality of varistors 27, 29, 31 and 33. These act together as a surge suppressor and could be replaced with other combinations of varistors without exceeding the scope of the invention. Collectively, these varistors have a capability of 80,000 joules (i.e. about 20,000 joules each) and preferably should be in the range of 10,000 to 20,000 or more joules. Dry film capacitor 35, in this case, has a capacity of 3 microfarads. This is followed by two chokes or transformers functioning as inductor/metal oxide varistor transformers. They each are set to operate at about 45 to 60 millihenries. Next, are liquid filled high intensity discharge capacitors 41 and 43 rated at 25 microfarads and 52 millifarads, respectively. Varistors 45 and 47 act together as back end surge suppressors. There is an optional lamp 49 which remains illuminated while device 2 is hooked up and functional, and which shuts down if device 2 is non-functional, a component fails, or the device is disconnected. This is also the case for the lamps described in conjunction with FIGS. 3 and 4 below.

FIG. 3 shows a wiring diagram for a two phase present invention device 301 which includes duplicate subsystems 303 and 305, connected as shown. Each of these subsystems is identical to the entire system 2 as shown in FIG. 2 above. Thus, subsystem 303 and subsystem 305 have both identical components to the system 2 of FIG. 2 and each component has identical values thereto. This particular embodiment is used in a two phase environment.

FIGS. 4a and 4b illustrate a wiring diagram for a three phase present invention system 401 which includes three separate subsystems or arrays 403, 405 and 407. These are also each identical to the system 2 shown in FIG. 2, except that subsystem 405 is less one ground. The subsystems are connected to one another as shown. These three phase systems of the present invention may be utilized as shown with any three phase configuration (e.g. y-type three phase and delta-type three phase systems).

Obviously, numerous modifications and variations of the present invention are possible in light of the above teaching. It is therefore understood that within the scope of the appended claims, the invention may be practiced otherwise than as specifically described herein.

What is claimed is:

1. A multiphase electricity pod controller device for use with a multiphase electrical power system, which comprises:
A. connection means for connecting said device in parallel electrical connection with an incoming power supply to a facility;
B. a plurality of subsystems, connected to said connection means and connected in parallel with one another, each of said subsystems including:
(a) a ground connection;
(b) a first stage component, including identifying means to recognize electromagnetic interference, and means to respond thereto by suppressing live transient voltage surges, said first stage component also including at least one line transient voltage surge suppressor (TVSS);
(c) a second stage component, including at least one variable inductor to regulate the total harmonics distortion (THD) and thus enhance power factor correction; and,
(d) a third stage component, including means to provide power to maintain phase regulation to incoming power, thus, to maintain true phase relationship between voltage and current at times of increased power demands, said third stage component including at least one power storage and discharge means.

2. The multiphase electricity pod controller device of claim 1 wherein said first stage component, second stage component and third stage component of each of said plurality of subsystems have substantially identical individual components.

3. The multiphase electricity pod controller device of claim 1 wherein there are at least two sets of subsystems, wherein said device operates as a two phase device.

4. The multiphase electricity pod controller device of claim 1 wherein there are three set of subsystems, wherein said device operates as a three phase device.

5. A multiphase electricity pod controller device, which comprises:
A plurality of subsystems, each of said subsystems including:
(a) connecting means for connection to an incoming power supply of a facility, for connection in parallel, including a hot line and a neutral line, and at least one ground, and having the following components connected between said hot line and said neutral line, in the following order:
(b) at least one front metal oxide varistor line transient voltage surge suppressor having a predetermined number of joules capability to suppress undesired power spikes;
(c) at least one capacitor of predetermined capacitance;
(d) at least two chokes in the form of inductor/metal oxide varistor transformers;
(e) at least a second capacitor of its own predetermined capacitance;
(f) at least one back metal oxide varistor having a predetermined number of joules capability;
wherein each of said plurality of subsystems are connected to one another.

6. The multiphase electricity pod controller device of claim 5 wherein said at least one front metal oxide varistor is a plurality of varistors in parallel.

7. The multiphase electricity pod controller device of claim 5 wherein said at least one back metal oxide varistor is a plurality of varistors in parallel.

8. The multiphase electricity pod controller device of claim 7 wherein said at least one front metal oxide varistor is a plurality of varistors in parallel.

9. The multiphase electricity pod controller device of claim 5 wherein said components (a) through (f) are duplicated therein to form two connected subsystems and are arranged for operation as a two phase device.

10. The electricity pod controller device of claim 9 wherein said at least one front metal oxide varistor is a plurality of varistors in parallel.

11. The electricity pod controller device of claim 9 wherein said at least one back metal oxide varistor is a plurality of varistors in parallel.

12. The multiphase electricity pod controller device of claim 5 wherein said components (a) through (f) are triplicated therein to form three connected subsystems and are arranged for operation as a three phase device.

13. The multiphase electricity pod controller device of claim 12 wherein said at least one front metal oxide varistor is a plurality of varistors in parallel.

14. The multiphase electricity pod controller device of claim 12 wherein said at least one back metal oxide varistor is a plurality of varistors in parallel.

15. The multiphase electricity pod controller device of claim 5 which further includes at least one indicator lamp connection and lamp wired so as to illuminate when said device is functional and to not illuminate when said device is nonfunctional.

16. The multiphase electricity pod controller device of claim 9 which further includes at least one indicator lamp connection and lamp wired so as to illuminate when said device is functional and to not illuminate when said device is nonfunctional.

17. The multiphase electricity pod controller device of claim 12 which further includes at least one indicator lamp connection and lamp wired so as to illuminate when said device is functional and to not illuminate when said device is nonfunctional.
